(19) United States
(12) Patent Application Publication
(10) Pub. No.: US 2013/0089371 A1
(43) Pub. Date: Apr. 11, 2013

(54) PRE-TENSIONING DEVICE BETWEEN TWO ELEMENTS MOUNTED IN SPACED RELATION ON AN AXLE

(71) Applicant: Mona Winkvist, Enkoping (SE)

(72) Inventor: Gunnar Winkvist, Enkoping (SE)

(73) Assignee: Mona Elisabet WINKVIST, Enkoping (SE)

(21) Appl. No.: 13/642,943

(22) PCT Filed: Apr. 28, 2011
(86) PCT No.: PCT/SE2011/050521

§ 371 Date: Oct. 23, 2012

(30) Foreign Application Priority Data
May 4, 2010 (SE) 1050439-7

(51) Int. Cl. F16D 1/072; F16B 4/00

(52) U.S. Cl. CPC F16D 1/072; F16B 4/00
USPC 403/361

(57) ABSTRACT

A device operative to generate a pre-tension between two elements which are to be mounted in spaced relation on an axle is disclosed. The device includes a first ring (1) and a second ring (2) configured to generate upon compression a substantially constant pre-tensioning force as the result of the first ring being pressed axially into the second ring against the force of a radial expansion of a portion of the first ring which is superimposed onto the second ring. The second ring has an annular notch (7) which is defined in radial directions between an inner wall (9) and an outer wall (8) and which opens towards the first ring which is insertable into the notch, wherein the radius to the outer wall (8) of the notch is determined such that the outer wall prevents further radial expansion of an expanded portion of the first ring.

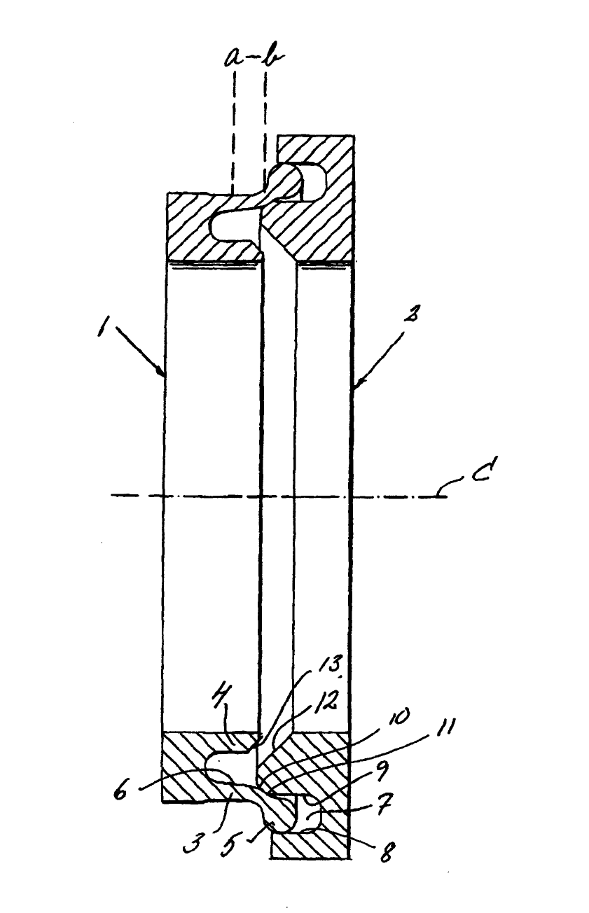

### TECHNICAL FIELD OF THE INVENTION

The present invention refers to a device configured for insertion between two elements which are to be mounted in spaced relation on an axle. In mounted position, the device is effective to generate a force by which the two elements are pre-tensioned away from each other in the axis direction of the axle. More precisely, the present invention refers to a pair of co-operating rings forming a pre-tensioning set for this purpose.

### BACKGROUND AND PRIOR ART

The assembly of components in, e.g., drive lines and power transmissions, often involves setting of a proper pre-tension between components such as bearings, gears, or spacer elements etc. which are to be arranged within prescribed tolerances on a common axle. A conventional way of achieving this is through the use of spacers or shims by which the pre-tension can be adjusted. This is typically accomplished by mounting the components and the inter-positioned shims on the axle before the function of the assembly is tested under operational load conditions, while the relative movement or play between components is measured. In the worst scenario, disassembly and assembly is repeatedly required in order to achieve the desired pre-tension through the use of shims.

A compressible clamping ring is previously known for this purpose, the ring comprising a circumferential deformation indication at which a middle section of the ring is controlled to bend outwards when the clamping ring is compressed in axial direction. A disadvantage in this clamping ring is its limited ability to spring back after being compressed, which may lead to play and loss of pre-tension in the assembly. Another drawback is the risk of rupture of the clamping ring at the deformation indication, as well as difficulties of dimensioning the clamping ring in order to avoid rupture.

SE 9801410-3 describes for the same purpose a two-part clamp ring set in which a first and a second ring, both of metal, are formed to generate upon compression a pre-tensioning force that is the result of the first ring being axially displaced on the exterior of the second ring against the force of a radial expansion of that portion of the first ring which is superimposed on the second ring. Albeit this two-part clamping ring has worked satisfactory within the load cases for which it is dimensioned, strength may be a problem in connection with higher loads than those for which the ring is dimensioned, in case of which the edge of the expanded outer ring may rupture.

### SUMMARY OF THE INVENTION

The present invention aims to avoid the problems of the prior art as described above. A special object of the invention is to provide a device by which the integrity and function of a pre-tensioned mechanical joint can be ensured also if the mechanical joint is subjected to abnormal loads during operation.

In order to meet this object, the present invention comprises a first ring and a second ring formed to generate upon compression a pre-tension force that is the result of the first ring being axially displaced on the exterior of the second ring against the force of a radial expansion of that portion of the first ring which is superimposed on the second ring, wherein characterizing features of the invention prescribes that the second ring has an annular notch that is defined radially between an inner wall and an outer wall, and which opens towards the first ring which is insertable into the notch, wherein the radius to the outer wall of the notch is set to delimit continued radial expansion of an expanded portion of the first ring.

The notch has a bottom and the depth of the notch is adapted to the length of the expandable portion of the first ring which is insertable into the notch, the notch this way providing a definite insertion depth that precludes further expansion of the first ring before the rupture limit for the ring material is reached.

By controlling this way the expanding ring towards the outer wall of the notch, the radial expansion of the ring is delimited and elongation of the material can be kept below the rupture limit. The purpose of the notch and its outer wall is thus to prevent rupture of the material at the edge of the expanding ring. In addition, friction generated through contact with the outer wall will absorb a portion of the total load on the rings. The depth of the notch can further advantageously be set such that the bottom of the notch, which obviously connects the walls of the notch in the second ring, determines and delimits the possible length of relative displacement between the rings. The invention this way ensures that the rings and the mechanical joint remain intact also after an abnormal axial load which would otherwise have caused an excessive compression of the rings possibly resulting in rupture of the expandable first ring. In turn, this feature of the invention ensures that integrity of components and function in the assembly is maintained also after an abnormal and exaggerated load being applied.

It is preferred that the portion of the first ring which is superimposed on the second ring is controlled to expand outwardly towards the outer wall of the notch. To this purpose, the inner wall of the notch is formed with a conical portion running circumferentially at the mouth region of the notch. Since the expansion of the first ring is this way caused at the mouth of the notch, the axial length of the second ring can be reduced.

It is further preferred that the conical portion connects to the inner wall of the notch via an arcuate and convex transition region. This way it is ensured that the rings can be pressed together without material being scraped off from the expanding portion of the first ring.

In a preferred embodiment the first ring comprises a ring main body from which a radially outer wall extends rotationally symmetric towards a free end which can be superimposed on the second ring. This outer wall can be arcuately curved from the centre axis of the ring as viewed in the direction towards the free end.

The free end of the outer wall of the first ring further preferably comprises a circumferential bulge, the cross-sectional dimension of which is only slightly less than the width of above said notch between the outer and inner walls of the notch. Said bulge may advantageously have a part-circular cross section, or has at least an exterior which permits sliding against the outer wall of the notch.

In order to compensate the loss of power that arises when the material passes its yield point, the outer wall of the first ring may have an increasing radial thickness from the free end towards the ring main body, preferably in the form of an inner periphery which is slanting in relation to the centre axis of the ring.

In an advantageous embodiment the inner periphery of the outer wall of the first ring connects to the ring main body through a radius, and the ring main body continuous via a radius to an outer periphery of an inner wall which extends from the ring main body to form an extension of a centre bore through the ring main body. This embodiment provides increased torsional rigidity to the first ring which in result can be formed with less axial length.

In order that the second ring be adapted to the configuration of the first ring, the second ring may be formed with a centre bore having a countersink into which the inner wall of the first ring is insertable when the rings are pressed together.

The inner wall of the above mentioned notch is formed with a radius, especially at the arcuate transition to the conical portion, which is adapted to the tensile yield point of the material forming the expandable portion of the first ring.

In a preferred embodiment, the expandable first ring is produced in steel having a wide yield interval permitting elongation of at least 20%, preferably permitting elongation of >25%, and most preferred having an elongation of about 30%.

The first ring may alternatively be produced in steel having a less wide yield interval or having a comparatively narrow yield interval in applications where a stronger back-springing effect is desired in the mechanical joint. For this purpose, the first ring may be produced in steel providing elongation up to 20% at the most, preferably an elongation of <15%, and most preferred an elongation of about 10%.

In its basic realization, the invention comprises two individual rings that are mountable on an axle. In an alternative embodiment at least one of the first and/or second rings forms an included or integrated part of an element that is mountable on an axle. In yet an alternative embodiment the first or the second ring forms an included or integrated part of an axle.

### DETAILED DESCRIPTION OF A PREFERRED EMBODIMENT

A preferred embodiment of the invention will be further explained below with reference made to the accompanying drawing which shows, in a sectional plane through a centre axis C, a pre-tensioning device in the form of an expanding ring and a base ring shown in a partially compressed state. In the illustrated state, an expanded portion of the left hand ring or the expanding ring 1 is brought in bearing contact with an outer wall of a notch formed in the right hand ring or base ring 2. In the drawing, the expanded portion is a forward portion of an expandable length a-b of the expanding ring 1, or more precisely, a forward length of a rotationally symmetric wall formed on the expanding ring.

In other words, the device of the present invention comprises a first ring or expanding ring 1 and a second ring or base ring 2. Basically, the rings are formed with a centre bore to permit mounting onto an axle going through the bores (the axle not shown).

The expanding ring 1 comprises a ring main body from which an outer wall 3 extends rotationally symmetric mainly in the axial direction. The outer wall connects via a radius to the ring main body, which in turn connects via a radius to an inner wall 4 which extends in the axial direction, in concentric relation with the outer wall 3. The inner wall 4 forms an extension of the ring main body about the centre bore and provides torsional rigidity to the expanding ring. The outer wall 3 has a wall thickness that increases from an end 5 towards the ring main body, in the illustrated embodiment achieved as the outer wall has an inner surface or periphery 6 that is slanting relative to the centre axis C. The free end 5 is arcuately curved and terminated in a bulge, the purpose of which is to add strength to the edge and facilitate insertion into a notch 7 formed in the meeting opposite end of the base ring 2.

The base ring 2 comprises a ring main body in which is formed an annular notch 7 which opens in that end of the base ring 2 which faces the expanding ring 1. The notch 7 is defined radially between an outer wall 8 and an inner wall 9, the walls advantageously connecting under a radius respectively to the ring main body in the bottom region of the notch. The notch 7 has a depth in axial direction which is adapted to the available and suitable length of insertion of an expanded portion of the expanding ring 1, as will be more closely explained below. In the mouthing region of the notch 7, the inner wall of the notch connects to a circumferential conical portion 10 which in turn connects to the inner wall 9 via an arcuate and convex transition region 11. The ring main body may further be formed with a countersink 12 running circumferentially about the centre bore and into which the inner wall 4 of the expanding ring 1 is received upon pressing the rings together.

Shaped as described above, the rings 1 and 2 are adapted to be pressed into each other. More precisely, the free end 5 of the outer wall 3 of the expanding ring 1 is designed with an inner radius that permits an end region of the wall 3 to be superimposed onto the conical portion 10 of the base ring 2. Since said inner radius, as mentioned above, is reducing towards the ring main body of the expanding ring, the conical portion 10 will cause expansion of the wall 3 in radial directions when the rings are pressed together. It will be seen that conical portion 10 and its transition to the inner wall of the notch 7 shall for this purpose be dimensioned with a corresponding radius in order to generate the desired expansion. The conical portion 10 may be designed with a planar or with a convex surface and is slanting relative to the centre axis C at an angle of about 30-60°, preferably at an angle of 45°.

In this connection it should also be explained that the outer diameter of the free end of the wall 3 shall initially be less than the inner radius of the outer wall 8 of the notch 7. Expansion of the wall 3 can this way begin without generation of frictional forces between the free end 5 and the inner surface of the outer wall of the notch. Accordingly, the drawing shows the wall 3 in a partially expanded state wherein the free end of the wall is expanded radially into contact with the outer wall of the notch. Continued pressing together of the rings requires that also a generated frictional force must be overcome in addition to the force required for expansion of the wall 3.

It should also be mentioned that the part-circular shape of the bulge in the free end of the wall 3 which is illustrated in the drawing is merely a non-limiting example of design. It will be understood that the bulge shall have a cross-sectional dimension that is less than the width of the notch 7. Preferably the bulge has a dimension which is only slightly less than the width of the notch 7, such as one or a few tenths of a millimetre less, in order this way to provide a well-defined contact with the bottom of the notch and a definite stop and limitation of the possible length of insertion of the wall 3 into the notch 7. In this end position, the compressed device is unelastic and the integrity of the rings will be preserved also if an abnormal load is applied against the device. This safety aspect of the device can be additionally supported by forming the above mentioned countersink 12 so as to simultaneously bear against the end of the inner wall 4 of the expanding ring 1. To this purpose, the rings of the illustrated embodiment are formed with opposite slanting faces 12 and 13.

The rings 1 and 2 are preferably manufactured from steel. The expandable wall 3 is to be dimensioned with respect to the elasticity of the subject steel such that the expandable portion of the wall is brought to the yield pint of the material when a desired load case/desired pre-tension is reached, and the wall is expanded towards the conical portion 10. For a certain application it may be desired to choose a material having a high yield point and a wide yield interval, whereas in another application it may be desired to choose a material with less elongation, such as when a stronger back-springing force is expected from the pre-tensioning device. In all cases the wall 3 shall be dimensioned such that the material becomes plastic at the subject load. When the desired pre-tension and corresponding deformation is reached, the material turns into an elastic condition under a permanent deformation of the expanded portion of the wall 3. Further compressing of the rings and accompanying further deformation of the wall requires a force above the pre-tensioning force. The increasing thickness of the wall 3 towards the ring main body means that additional material is successively moved into the deformation zone, this way compensating for the loss of resistance that initially occurs when the material passes the yield point and turns into a plastic condition.

A detailed specification on ring dimensions and material is not made herein since each application requires a skilled person's consideration in these aspects as well as consideration of available installation space. As an example though it can me mentioned that in a device dimensioned for a pre-tension of 80 kN, a test sample of the expanding ring 1 was milled from a steel having an elongation (A₅) of 30%. For the base ring 2 a less elastic steel may be chosen, such as a steel that does not require subsequent treatment in the form of heat treatment, e.g. The expandable first ring 1 was milled to an outer diameter of 80 mm, an inner diameter of 62.11 mm, an axial length of 17.63 mm, a radius at the transition to the expandable portion of 37.9 mm and a maximum radius of the expandable portion amounting to 39 mm. The thickness of the expandable wall was successively increased by means of a slanting inner periphery from a thickness of 2 mm in the free end of the wall to about 2.5 mm at the region where the wall connects to the ring main body of the expandable first ring 1. Further in the test rings, the depth of the notch 7 amounts to 6.43 mm, and the outer wall 8 extends from the ring main body of the base ring or second ring 2 for a length of 12.10 mm. In the test sample, the maximum insertion length amounts to approximately 3.5 mm before the expanding ring abuts the bottom of the notch in the base ring. The expandable portion further has an operative length of about two mm within which the material remains plastic under a load of 80 kN.

### Advantages and Feasible Modifications of the Invention

In a meritorious way the present invention replaces conventional shims and compressible clamping rings of prior art. Among the advantages provided by the invention are:
The need for demounting a mounted assembly to replace inserted shims is avoided
The need for storage of shims of different thickness is avoided
Simplified handling since a set of rings can be shipped in a compressed condition as one unit
Simplified mounting since a set of rings can be shipped in a compressed condition as one unit of specified length
Simplified mounting of rings and components on an axle by compression of the rings to a predetermined tightening torque, and a follow-up tightening of the assembly if required while maintaining the tightening torque between the rings
The possibility of setting up an automized mounting process
The risk of rupture is avoided through a controlled deformation of the expanding ring
The risk for rupture is reduced or avoided by the formation of a strongly enlarged thickness at the edge of the expanding ring
The risk for rupture due to an overload is avoided through the provision of a defined end stop for available compression length

Notwithstanding the fact that the invention has been described above in a basic form comprising a set of first and second rings it will be understood, without drawing illustrations required, that at least one of the rings may alternatively constitute a detail that is included or integrated in an element which is mountable on an axle. Similarly, one of the rings may constitute a detail that is included or integrated in an axle without departing from the invention as defined in the claim. In such alternative embodiment the ring main body of the subject ring forms a part of the element or axle in which the operative means are formed to provide in cooperation the technical effect as explained above. Neither is the invention necessarily limited to applications wherein steel is the most suitable material for both of the rings. On the contrary, the invention covers embodiments wherein at least one of the rings is manufactured from other metal of from non-metallic material.

1. A device operative to generate a pre-tension between two elements which are to be mounted in spaced relation on an axle, the device comprising a first ring (1) and a second ring (2) configured to generate upon compression a pre-tensioning force as the result of the first ring being pressed axially into the second ring against the force of a radial expansion of a portion of the first ring which is pressed into the second ring, wherein the second ring (2) has an annular notch (7) which is defined radially between an inner wall (9) and an outer wall (8), the notch (7) opening towards the first ring (1), wherein the inner wall (9) of the notch, at least in a mouth area of the notch, has a radius which causes radial expansion of an expandable portion of a rotationally symmetric wall (3) formed on the first ring (1) when said wall portion is inserted into the notch, and the outer wall (8) of the notch has a radius to prevent further radial expansion of the previously expanded portion of the rotationally symmetric wall (3) when the first ring (1) is pressed further into the second ring (2).

2. The device of claim 1, wherein the notch (7) has a bottom and a depth that is adapted to the length of the expanded portion of the first ring (1) insertable into the notch, and which provide a definite stop for insertion that prevents further expansion of the first ring before the rupture limit of the ring material is reached.

3. The device of claim 2, wherein the inner wall (9), at the area of the mouth of the notch, comprises a circumferentially running conical portion (10) against which the inserted portion of the first ring (1) is forced to expand outwardly and towards the outer wall (8) of the notch, as the rings are pressed together axially.

4. The device of claim 3, wherein the conical portion (10) connects to the inner wall (9) of the notch via an arcuate and convex transition region (11).

5. The device of claim 1, wherein the first ring (1) comprises a ring main body from which an outer wall (3) extends rotationally symmetric towards a free end (5) that can be superimposed on the second ring (2).

6. The device of claim 5, wherein the outer wall (3) of the first ring (1) is arcuately curved from a centre axis (C), towards the free end (5).

7. The device of claim 5, wherein the free end (5) of the outer wall of the first ring comprises a circumferentially running bulge having a cross-sectional dimension which is only slightly less than the width of the notch (7) between the outer and inner walls of the notch.

8. The device of claim 5, wherein the outer wall (3) of the first ring (1) has a radial thickness that increases from the free end of the wall towards the ring main body, preferably in the form an inner periphery (6) that is slanting relative to the centre axis (C) of the ring.

9. The device of claim 5, wherein said inner periphery (6) of the outer wall of the first ring connects to the ring main body via a radius, and in that the ring main body connects via a radius to an outer periphery of an inner wall (4) which extends from the ring main body to form an extension of a centre bore through the ring main body.

10. The device of claim 9, wherein the second ring (2) comprises a centre bore formed with a countersink (12) into which the inner wall (4) of the first ring (1) is insertable upon pressing the rings together.

11. The device according to claim 1, wherein the inner wall (9) of the notch, at least in the region of the arcuate transition to the conical portion (10), has a radius which is designed in consideration of the yield point of the material forming a superimposed portion of the first ring.

12. The device according to claim 1, wherein the first ring (1) is manufactured from steel having a wide yield interval and an elongation of at least 20%, preferably an elongation of >25%, and most preferred an elongation of about 30%.

13. The device of claim 1, wherein the first ring (1) is manufactured from steel having a narrow yield interval and an elongation of up to 20%, preferably an elongation of <15% and most preferred an elongation of about 10%.

14. The device according to claim 1, wherein at least one of the first (1) and second (2) rings constitutes an included or integrated part of an element that is mountable onto an axle.

15. The device according to claim 1, wherein the first (1) or second (2) ring constitutes a part included or integrated in an axle.

16. The device of claim 2, wherein the first ring (1) comprises a ring main body from which an outer wall (3) extends rotationally symmetric towards a free end (5) that can be superimposed on the second ring (2).

17. The device of claim 3, wherein the first ring (1) comprises a ring main body from which an outer wall (3) extends rotationally symmetric towards a free end (5) that can be superimposed on the second ring (2).

18. The device of claim 4, wherein the first ring (1) comprises a ring main body from which an outer wall (3) extends rotationally symmetric towards a free end (5) that can be superimposed on the second ring (2).

19. The device of claim 6, wherein the free end (5) of the outer wall of the first ring comprises a circumferentially running bulge having a cross-sectional dimension which is only slightly less than the width of the notch (7) between the outer and inner walls of the notch.

20. The device of claim 6, wherein the outer wall (3) of the first ring (1) has a radial thickness that increases from the free end of the wall towards the ring main body, preferably in the form an inner periphery (6) that is slanting relative to the centre axis (C) of the ring.
